(19) United States
(12) Patent Application Publication
(10) Pub. No.: US 2016/0376891 A1
(43) Pub. Date: Dec. 29, 2016

(54) METHOD FOR COOLING A TURBOENGINE ROTOR, AND TURBOENGINE ROTOR

(71) Applicant: ANSALDO ENERGIA IP UK LIMITED, London (GB)

(72) Inventors: Cyrille BRICAUD, Rheinfelden (DE); Carlos SIMON-DELGADO, Baden (CH); Thomas ZIERER, Ennetbaden (CH); Ulrich Robert STEIGER, Baden-Dattwil (CH); Stephan STRUEKEN, Zurich (CH); Christoph DIDION, Wettingen (CH)

(73) Assignee: ANSALDO ENERGIA IP UK LIMITED, London (GB)

(21) Appl. No.: 15/192,510

(22) Filed: Jun. 24, 2016

(30) Foreign Application Priority Data
Jun. 26, 2015 (EP) 15174057.8

(51) Int. Cl. F01D 5/08; F01D 5/30; F01D 5/18

(52) U.S. Cl. CPC F01D 5/081; F01D 5/18; F01D 5/3007; F05D 2220/32; F05D 2240/60; F05D 2240/81

(57) ABSTRACT

A method and device for cooling a turboengine rotor. A blade member includes a platform having a hot gas side and a coolant side. An airfoil is on the platform hot gas side and a blade foot section is on the platform coolant side. The blade foot section includes a blade shank and a blade root. The blade shank extends from the platform coolant side and is interposed between the blade root and the platform coolant side. The blade root includes root fixation features and is received by a fixation feature of a rotor shaft. A first fluid flows along the rotor front face and into a cavity of the blade shank and a second fluid flows within the blade shank cavity. The first fluid flow is relatively colder than the second fluid flow and a combined shank cavity fluid flow is formed inside the blade shank cavity.

### TECHNICAL FIELD

The present disclosure relates method for cooling a turboengine rotor according to claim 1. It further relates to a turboengine rotor and a cover plate for said turboengine rotor as described in the further independent claims.

Further disclosed is a gas turbine comprising a rotor and/or a cover plate according to the present disclosure.

### BACKGROUND OF THE DISCLOSURE

In a rotor of a turboengine, such as, for instance, a gas turbine, blade shank cavities are commonly present and are delimited by e.g. the shanks of two circumferentially neighboring blades, the respective blade roots, the respective blade platforms, and the rotor shaft. These blade shank cavities commonly are also located adjacent a load bearing blade-shaft interface.

In particular in gas turbine engines, and more in particular in the first stages of an expansion turbine of a gas turbine engine, a coolant may be required within the blade-shank cavity in order to cool the thermally heavy loaded blade platforms, and also purge the cavities from high temperature working gases. Coolant or a purge flow may for instance be supplied by compressed air from a gas turbine compressor. Thus, the coolant or purge flow is expensive as it results in a detrimental effect on the engine efficiency through a loss of working fluid providing useful work.

US 2005/0201857 proposes to guide cooling air from a cooling air plenum formed between the bottom of the blade root and the bottom of a receiving groove formed in the rotor shaft into the blade shank cavity, thus pressurizing the blade shank cavity and cooling the platform. The document further proposes to guide this air along the front face of rotor shaft posts in order to create an air curtain guiding the coolant along the platforms and to prevent or at least inhibit the entry of relatively hotter pre-used air from an upstream space. However, the teaching of this documents leads to the necessary utilization of expensive fresh cooling air within the blade shank cavity.

US 2009/0175732 to the contrary proposes to admix a flow of recuperated cooling air with a rim purge flow in order to purge the blade-shank cavity against hot gas ingestion and also to cool the platforms. One issue which might be related to the teaching of US 2009/0175732 may be seen in the fact that this air could enter an interface between the blade root and the rotor posts. While the material of the blade member, comprising the platform, the shank, and the blade root, can easily withstand elevated temperatures, the rotor shaft may be made of a material with a lower high temperature resistance. Thus, leakage of an elevated temperature fluid into the interface between the blade root and the rotor shaft may compromise lifetime and overspeed margin of the load bearing shaft-blade interface on the rotor shaft side.

US 2014/0193272 proposes supplying two different coolant flows to a blade-shank cavity, wherein two coolant flows may exhibit different temperatures. One relatively warmer of said coolant flows may be guided and metered through an aperture in a cover plate. A second relatively colder of said coolant flows is intended to flow along a gap formed at the interface between the blade root and the rotor shaft posts and to be discharged at the downstream end of the blade root. Accordingly, the expensive colder cooling air does not participate in cooling the platforms.

### LINEOUT OF THE SUBJECT MATTER OF THE PRESENT DISCLOSURE

It is an object of the present disclosure to provide an improved method and device for cooling a turboengine rotor. It is a further object of the present disclosure to provide a method and device for cooling a turboengine rotor which preserves the integrity of the mechanically highly loaded blade-shaft interface in preventing fluid with an excessive temperature from getting into contact with the rotor shaft. In another aspect, it is an object of the present disclosure to provide a method and device for cooling a turboengine rotor improving the utilization of the coolant. In still a further aspect it is an object of the present disclosure to provide a method and device for cooling the turboengine rotor which reduces the coolant consumption. It is a further object of the present disclosure to provide a method and device for cooling the turboengine rotor which avoids overcooling certain components which can withstand elevated temperatures, such as, for instance, the blade platforms, while providing insufficient cooling to components which are made from materials of relatively lower high temperature strength, such as, for instance, the shaft. A further object of the disclosed subject matter may be seen in the fact that it allows to join components made from largely different high temperature strength.

This is achieved by the subject matter described in claim 1 and further by the subject matter described in the independent device claim.

Further effects and advantages of the disclosed subject matter, whether explicitly mentioned or not, will become apparent in view of the disclosure provided below.

Accordingly disclosed is a method for cooling a turboengine rotor, the rotor comprising a rotor shaft and at least one blade member. The blade member comprises a platform, wherein the platform comprises a hot gas side and a coolant side. An airfoil is provided on the platform hot gas side and a blade foot section is provided on the platform coolant side, wherein the blade foot section comprises a blade shank and a blade root. The blade shank extends from the platform coolant side and is interposed between the blade root and the platform coolant side, the blade root comprising root fixation features provided on the blade root and is received by a fixation feature of the rotor shaft. It is understood that the blade root and the fixation feature of the rotor shaft are provided as features interlocking the blade root and the rotor shaft at least in a radial direction of the rotor. The fixation features of the blade root and the rotor shaft thus form corresponding mating fixation features. The fixation feature of the rotor shaft may in particular be a female fixation feature, and the fixation features of the blade root may be received within the fixation feature provided on the rotor shaft. To this extent, the blade root comprises root fixation features on lateral sides thereof, that is sides pointing into a circumferential—however not necessarily exclusively circumferential—direction when the blade member and the rotor shaft are assembled as a rotor. It is further understood that the fixation features on the blade root may be shaped to form a so-called fir tree root, and accordingly the fixation feature provided at the rotor shaft may be a so-called fir tree groove. Fir tree fixation is well-known in the art. The rotor shaft fixation feature extends from a rotor front face and is provided on posts formed on the rotor shaft. To the extent the rotor shaft fixation feature is a female fixation feature, it may be said that the rotor shaft fixation feature is provided between posts formed on the rotor shaft. In other embodiments the rotor shaft fixation feature may be provided by a rotor shaft post. It is further understood that the rotor front face may be an annular front face disposed around a shaft core and providing axial access to a fixation feature provided by the rotor shaft. The posts extend with in an axial direction of the rotor shaft from the front face, and likewise it may be said that grooves provided therebetween extend in the axial direction of the shaft. In this respect it should be understood that extending in an axial direction is not to be restricted to a merely axial direction, while said orientation is comprised, but the extent of the posts or grooves, respectively, comprises an axial component. An interconnection interface, which in particular may extend axially, is thus formed between the respective fixation features provided on the blade root and the rotor shaft and extending to the rotor front face, and forms an interface seam on the rotor front face. In case the blade root is received within a female fixation feature of the rotor shaft, a lateral interface is formed between each lateral side of the blade root and a post, and extending to the rotor front face and forming an interface seam on the rotor front face. Further, a blade shank cavity is provided adjacent the platform coolant side. The method comprises guiding a first fluid flow along the rotor front face and into the blade shank cavity, whereby a second fluid flow is able to enter the blade shank cavity. The method further comprises choosing the source of the first fluid flow such that the first fluid flow exhibits a relatively lower temperature, or is relatively cooler than the second fluid flow, respectively, and admixing the second fluid flow with the first fluid flow inside the blade shank cavity such as to form a combined blade shank cavity fluid flow. It will be appreciated that the second fluid flow may in some embodiments be purposefully be provided to the blade shank cavity, as will be lined out in more detail below. In other embodiments, it the second fluid flow may be a leakage flow. In this respect, it may be appreciated that be virtue of the herein disclosed subject matter it will be possible to allow this leakage flow to enter the blade shank cavity, and to accept larger leakage mass flows than possible in the art, and in certain embodiment of the herein disclosed subject matter the expense for providing sealings to avoid or reduce said leakage flows may thus be considerably reduced.

It will furthermore be appreciated that a multitude of blades may be provided, with the respective blade roots being fixed in a corresponding multitude of fixation features which are provided around the circumference of the rotor shaft.

As will be appreciated, the method bears several advantages over the art. It provides for the possibility to save expensive coolant at a low temperature level which is not required for the purpose. This is achieved in that a warmer coolant flow which may be too hot for the purpose is admixed with a coolant flow which is colder than required. Thus, the required coolant temperature may be adjusted in skillfully adjusting the mass flow ratio of the first and the second fluid flow. This serves to considerably reduce the first fluid mass flow of expensive low temperature coolant. Likewise, a flow of e.g. preheated purge air for a cavity upstream the respective blade row may be at least partly re-used instead of wastefully having it leaking into a main working fluid flow, that is, the fluid flow of the engine which is guided along the blade airfoils in order to generate useful work. Losses due to the reduction of the working fluid temperature as well as mixing losses and losses due to an unfavorable influence on the main working flow field may be reduced, if not avoided. Likewise, other pre-used coolant present at an elevated temperature may be reused in that, in admixing it with a colder fluid flow, the overall coolant temperature in the blade shank cavity is reduced to a level below the temperature of the pre-used coolant. A reduction of the overall coolant mass flow requirement of the engine is achieved, resulting in performance gains. In other embodiments, in applying the method, larger leakage flows into a blade shank cavity may be tolerated, thus reducing the expense for appropriate sealing systems, and, again, the potential to save expensive low temperature coolant.

The coolant may in particular embodiments be cooling air. It may for instance be bled from a gas turbine compressor and being supplied to a gas turbine expansion turbine for cooling purposes.

In another aspect, the method may comprise that the first fluid flow is selectively guided over the interface seam present on the rotor front face before entering the blade shank cavity. Thus, in particular the mechanically highly loaded parts of the rotor shaft, which may, as mentioned above, be made from a material having a lower high temperature strength compared to that of the blade members, are protected from being exposed to the combined fluid flow and/or the second fluid flow, which both are at a comparatively higher temperature than the first fluid flow. Consequently, these parts are maintained at a reduced temperature level, which results in an extended lifetime as well as an improved overspeed margin.

The method may in another aspect comprise extracting the first fluid flow from a coolant plenum which is provided between a base of a groove formed between adjacent rotor shaft posts, for instance, a female fixation feature, and the blade root. Thus, an easily accessible coolant reservoir is used. This may moreover facilitate guiding the first fluid flow along the above-mentioned interface seams. Said coolant plenum may in particular also be fluid communication with cooling ducts provided in the blade airfoil, for instance through channels formed in the blade foot section. In this respect, the coolant plenum may constitute a coolant supply also for the airfoil, and may be referred to as the blade coolant supply plenum. Moreover, it will be appreciated that the first fluid flow, while flowing from a radially inner blade coolant supply plenum to a radially outer blade shank cavity, benefits from a radial pumping effect increasing the total pressure of the fluid when the rotor rotates.

In another aspect the method comprises guiding the second fluid flow along a front face of one of the blade root and the rotor shaft post from a location radially inwardly from the blade shank cavity and into the blade shank cavity. It needs to be understood that the flow path of the second fluid flow is strictly restricted to a respective front face and will not be allowed to get into contact with an interface seam. The interface seam is shielded against the warmer second fluid flow by the colder first fluid flow guided along the interface seams. Thus, heat intake from the second fluid flow into the load bearing interfaces, formed between the rotor shaft posts and the blade roots, is avoided. Due to the centrifugal forces acting on the second fluid flow while being directed from a radially inner location to a radially outer location when the engine is operated, the second fluid flow gets pressurized in a way similar to a radial compressor while flowing along the front face of the blade root. The second fluid flow of elevated temperature is guided selectively along the front face of the blade root, while contact with the rotor shaft is avoided. Thus, the fluid flow of elevated temperature—before it is admixed with the first fluid flow and thus cooled down—only gets into contact with the component made of a material having sufficient mechanical high temperature strength.

In further embodiments of the method, the second fluid flow is a flow of pre-used coolant. Thus, the pre-used coolant becomes used for further purpose, instead of wastefully discharging it into the engine main flow, as described above. As already mentioned, the reuse of the pre-used coolant is possible in admixing it with a first fluid flow of a colder medium, thus providing a combined coolant flow having an appropriate temperature for platform cooling. Further, the second fluid flow may originate from a cavity, in particular a wheel cavity, provided adjacent the rotor front face.

It will further be appreciated that according to certain aspects of the present disclosure the first and the second fluid flow enter the cavity separate from each other. Admixing the fluid flows in order to form a combined blade shank cavity fluid flow takes place inside the blade shank cavity.

Disclosed is furthermore a turboengine rotor which is particularly suited for the implementation of the method described above.

In a first aspect, a turboengine rotor is disclosed, wherein the rotor comprises a rotor shaft and at least one blade member. The blade member comprises a platform, wherein the platform comprises a hot gas side and a coolant side, an airfoil being provided on the platform hot gas side and a blade foot section being provided on the platform coolant side. The blade foot section comprises a blade shank and a blade root, wherein the blade shank extends from the platform coolant side and is interposed between the blade root and the platform coolant side. The blade root comprises root fixation features being provided on the blade root and being received by a fixation feature of the rotor shaft, wherein the rotor shaft fixation feature extends from a rotor front face and is provided by posts formed on the rotor shaft. An interconnection interface is formed between the interconnection features being provided by the blade root and the rotor shaft, and extends to the rotor front face where it forms an interface seam on the rotor front face. A blade shank cavity is provided adjacent the platform coolant side. A first blade shank cavity supply duct is provided on the rotor front face and along the interface seam, and is in fluid communication with the blade shank cavity. In particular, a first shank cavity supply duct is provided on the rotor front face along each interface seam being formed on the rotor front face.

It will be readily appreciated that all remarks and explanations made above with respect to features relating to the rotor, or members of the rotor, respectively, fully apply to the disclosed turboengine rotor.

In a particular embodiment of the turboengine rotor a blade coolant supply plenum is provided between a base of the rotor fixation feature and the blade root, and is in particular in fluid communication with cooling ducts of the airfoil. The first blade shank cavity supply duct is in fluid communication with the blade shank cavity at a downstream end and is in fluid communication with said blade coolant supply plenum at an upstream end. In a more particular embodiment, a metering orifice is provided in a flow path between the blade coolant supply plenum and the blade shank cavity, and in particular between the blade coolant supply plenum and the first blade shank cavity supply duct. Said metering orifice may be provided in that a lug is provided extending from the base of the blade root and is partially locking the blade coolant supply plenum at the front face of the rotor, while leaving said metering orifice open.

In still a further embodiment of the turboengine rotor a second blade shank cavity supply duct is provided and is in fluid communication with the blade shank cavity at a downstream end. Said second blade shank cavity supply duct is provided along a front face of at least one of the blade root and the rotor shaft post. It needs to be understood that the location of the second shank cavity supply duct is strictly restricted to be arranged adjacent a respective front face and not at the interface seam. The interface seam is shielded against the warmer fluid flowing within the second shank cavity supply ducts by the colder fluid flowing in the first shank cavity supply ducts. Thus, heat intake from a fluid flowing in a second shank cavity supply duct into the load bearing interfaces, formed between the rotor shaft posts and the blade roots, is avoided. An upstream end of the second blade shank cavity supply duct is provided radially inwardly from the downstream end. That means, a fluid within said second blade shank cavity supply duct has a flow direction which is directed radially outwardly. During rotation of the rotor the fluid will thus be pressurized due to a radial pumping effect, similar to a radial compressor, while flowing from the upstream end of the duct to the downstream end of the duct, as already lined out above. However, it is noted that the second shank cavity supply duct is provided such as to be strictly separated from the load bearing structures of the blade root, and, accordingly, from the load bearing structures of the rotor shaft. Thus, fluid flowing inside the second shank cavity supply duct and along the front face of the blade root does not get into contact with the rotor shaft, at least not at the seams. Thus, this supply duct is particularly well-suited to guide the second fluid flow mentioned above, which in particular exhibits an elevated temperature, further in particular when compared to the first fluid flow.

In more particular embodiments, a cover plate is provided covering at least a part of the rotor front face. The first and second shank cavity supply ducts are provided between the rotor front face and the cover plate. Each of the ducts may be provided for instance by flutes provided on a face of the cover plate facing the rotor front face, on the rotor front face, or by a combination thereof.

Moreover, the upstream end of the second shank cavity supply duct may be provided as an aperture in the cover plate.

The cover plate may moreover be intended and serve to lock the blade members and the rotor shaft in axial direction. It may be locked to the rotor in being received at its radially inner and/or outer side in a circumferentially extending groove provided an the rotor shaft and/or on an inner diameter of the platform.

Further disclosed is a cover plate for a turboengine rotor of the kind mentioned above, wherein the cover plate comprises a first face and a second face and has a radial and a circumferential extent. As will be appreciated, the cover plate is intended for the use on the turboengine rotor, having a predefined location and orientation. Thus, the radial and the circumferential extent of the cover plate are well-defined by virtue of the cover plate as such. The first face is configured and arranged to be mounted facing the rotor front face, wherein at least one flute is provided on the first face of the cover plate. Said flute is arranged and configured to form a shank cavity supply duct when the cover plate is mounted on the rotor front face. At least one flute extends from a radially inner position to a radially outer position.

In some embodiments of a cover plate, comprising a first face and a second face and having a radial and a circumferential extent, the first face being configured and arranged to be mounted facing the rotor front face, wherein an aperture is provided between the first and the second face, the aperture is provided on a radially inner half of the cover plate. In more particular embodiments, at least one flute is provided on the first face of the cover plate, said flute being arranged and configured to form a shank cavity supply duct when the cover plate is mounted on the rotor shaft face, and said at least one flute extends from the aperture and to a position which is located on a larger radius than the aperture. The skilled person will appreciate that a flute provided on the cover plate and in fluid communication with the aperture is intended to form a second blade shank cavity supply duct and is intended for guiding the second fluid flow, or blade shank cavity supply flow.

In further aspects of the present disclosure, a turboengine, in particular a gas turbine engine, is disclosed comprising a rotor and/or a cover plate as described above.

It is understood that the features and embodiments disclosed above may be combined with each other. It will further be appreciated that further embodiments are conceivable within the scope of the present disclosure and the claimed subject matter which are obvious and apparent to the skilled person.

### BRIEF DESCRIPTION OF THE DRAWINGS

The subject matter of the present disclosure is now to be explained in more detail by means of selected exemplary embodiments shown in the accompanying drawings. The figures show

FIG. 1 a view of an exemplary expansion turbine stage;

FIG. 2 a front view of the rotor of the turbine stage of FIG. 1;

FIG. 3 a part view of the foot section of an exemplary blade member as may be used in the embodiment of FIGS. 1 and 2;

FIG. 4 an exemplary embodiment of a cover plate as may be used in the embodiment of FIGS. 1 and 2;

FIG. 5 a further exemplary embodiment of a turbine stage;

FIG. 6 an exemplary embodiment of a cover plate as may be used in the embodiment of FIG. 5;

FIG. 7 an exemplary embodiment of a cover plate as may be used in the embodiment of FIG. 1.

It is understood that the drawings are highly schematic, and details not required for instruction purposes may have been omitted for the ease of understanding and depiction. It is further understood that the drawings show only selected, illustrative embodiments, and embodiments not shown may still be well within the scope of the herein claimed subject matter.

### EXEMPLARY MODES OF CARRYING OUT THE TEACHING OF THE PRESENT DISCLOSURE

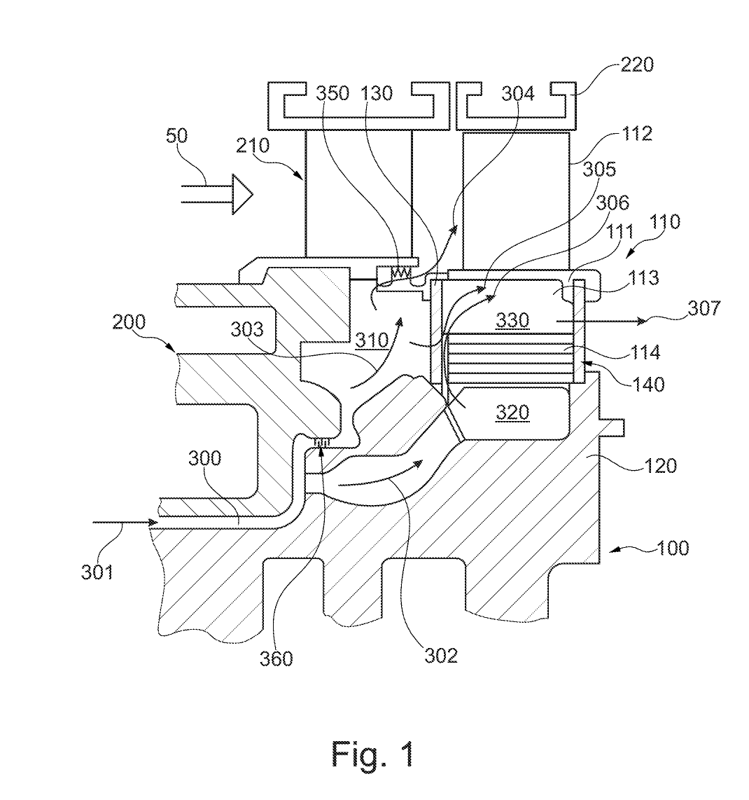

A first embodiment of applying the method and lining out the device according to the present disclosure is shown in FIG. 1. A gas turbine engine comprises a rotor 100 and a stator 200. Shown is a first stage of an expansion turbine, wherein a first stage is to be understood as a first stage downstream a combustor. In this respect, it may for instance also be a turbine stage which is arranged downstream a second combustor in a gas turbine engine with sequential combustion. The working fluid main flow 50 is flowing from the combustor to a stationary first vane 210, and will further flow towards the first row blade member 110, or the airfoil 112 thereof, respectively. The rotor comprises rotor shaft 120. A blade member 110 is received by fixation features of the rotor shaft 120 in a manner known in the art, for instance, in the present embodiment, a fir tree root may be received in a fir tree groove provided in the rotor shaft. The blade member 110 comprises a platform 111. The platform 111 comprises a hot gas side, facing the working fluid main flow, and on which the airfoil 112 of the blading member 110 is provided. It also comprises a coolant side, which is oriented towards the center of the rotor, or to the bottom in the present depiction. A blade foot section is disposed on the coolant side of the platform, comprising a fir tree blade root 114 and a shank 113 interposed between the blade root and the platform coolant side. A blade shank cavity 330 is formed adjacent the coolant side of the platform. A tip of the airfoil 112 faces a stator segment 220. An annular rim is formed on the rotor, from which the fir tree receiver grooves of the rotor shaft extent. This provides an annular rotor front face, which is essentially covered by a cover plate 130. In order to provide cooling for the thermally highly loaded components of the rotor, a coolant duct 300 is provided between the rotor 100 and the stator 200. A rotor main coolant flow 301 is guided through duct 300. As will be appreciated, the coolant may for instance be pressurized air bled from a gas turbine compressor. A first share 302 of the main coolant flow flows through the duct and the rotor and into a blade coolant supply plenum 320, which is provided between the blade root and a bottom of the fixation feature receiver groove provided essentially between the roots of two adjacent rotor posts, which in turn provide the rotor shaft fixation feature for fixing the blade root. A second share 303 of the rotor main coolant flow is guided through a labyrinth seal 360 which is formed between the rotor and the stator into a rim cavity 310 which is formed upstream the annular rotor front face and is delimited on its upstream side by parts of the stator 200. The coolant flows 302 and 303 may also originate from different sources, such as two bleeding points of a compressor. Said coolant flows may then have different pressure and accordingly different fluid temperature. Coolant fluid flows having different temperature may also be provided, for instance, in extracting a common fluid flow at one bleeding point of the compressor, and guiding a part flow thereof through a heat exchanger. A share of the rim cavity flow 303 exits through a further seal 350 into the working fluid main flow as rim cavity purge flow 304. Rim cavity purge flow 304 prevents hot gases from the working fluid flow 50 from entering rim cavity 310. In order to provide cooling for the blade platform 111, a first fluid flow 306 is guided from the blade coolant supply plenum 320 into the blade shank cavity 330. In addition, a second fluid flow 305 is allowed to flow from the rim cavity 310 and into blade shank cavity 330. It will be appreciated that the fluid flow 303 may already have heated up considerably inside the rim cavity. Thus, the second fluid flow 305 provided to the blade shank cavity is generally warmer than the first fluid flow 306 which is provided to the blade shank cavity 330 from the blade coolant supply plenum 320. Inside the blade shank cavity, the fluid flows 305 and 306 are admixed to form a combined fluid flow 307, which has a temperature between those of the first and second fluid flows, and is applied to cool the blade platform 111 and to purge the blade shank cavity 330. The combined blade shank cavity fluid flow may subsequently be discharged from the blade shank cavity, as schematically indicated by the arrow at 307, for instance in the region of a downstream cover plate 140.

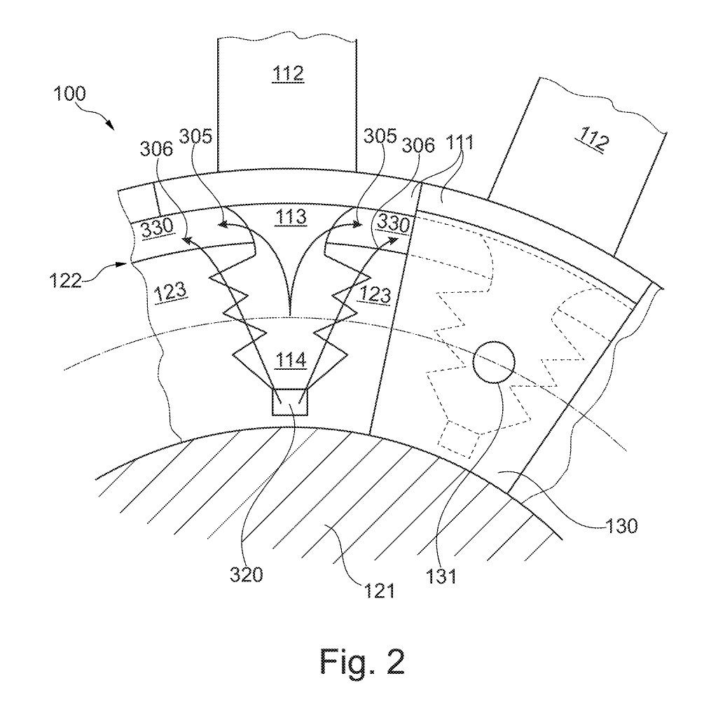

FIG. 2 depicts a front view onto the annular front face 122, or rim, of the rotor as shown in FIG. 1. The rotor front face 122 is annularly arranged around a rotor shaft core 121. Rotor shaft posts 123 provide fixation means for the blading members. Between adjacent rotor shaft posts 123 female fixation means in the shape of fir tree grooves, extending from the annular rotor front face, are formed, and receive fir tree roots 114 of the blade members. Shank cavities 330 are formed between adjacent blade shanks, platforms, and an outer radius of a rotor shaft post 123. For each blading member, a blade coolant supply plenum 320 is formed between the blade root 114 and the bottom of the respective receiving fir tree groove. Interconnection interfaces are formed between mating fixation features of the blade root 114 and rotor posts 123. Said interconnection interfaces extend to the rotor front face 122 and form interface seams thereon, which are depicted by the boundary between the rotor shaft post and the blade root. In the left part of the figure, a view without cover plate 130 is shown. First fluid flows 306 are guided from the blade coolant supply plenum 320 and along the interface seams into blade shank cavities 330. Second fluid flows 305 are guided selectively along the front face of the blade member foot section, which essentially consists of the blade shank 113 and the blade root 114, and into the blade shank cavities. As lined out above, within the blade shank cavities the two flows are admixed to provide a combined blade shank cavity fluid flow for cooling the platforms and purging the blade shank cavities. On the right side of the figure, an exemplary embodiment of a cover plate 130 is shown attached to the rotor front face. It is not mandatory, however conceivable, that the circumferential extent of the cover plate is identical with that of the blading member platform. It is moreover not mandatory, but conceivable, that a cover plate is arranged registry with a blade member. The cover plate 130 is provided with aperture 131 which is arranged on a radius, indicated by a dash-dotted line, which is smaller than the inner radius of a blade shank cavity 330, or the outer radius of rotor shaft post 123, respectively. Aperture 131 allows the second fluid flow 305 to enter ducts which are formed between the front face of the blade foot section and the cover plate 130, and to be introduced into the blade shank cavities 330. Likewise, ducts are provided to guide the first fluid flow 306 along the interface seams. Those ducts may be provided on the rotor posts and/or the blade root and the blade shank, respectively, or on a face of the cover plate 130 facing the rotor front face, or a combination thereof. As becomes apparent, the second fluid flow 305, which generally is present at a higher temperature than the first fluid flow 306, as lined out above, only is in contact with the blade member. The relatively colder first fluid flow 306 purges the interface seams against ingestion of hotter fluid, such that the load bearing structures of the rotor shaft posts 123 are protected against contact with hotter fluid. Thus, the rotor shaft, and in particular the load bearing features of the rotor shaft posts, are maintained at a generally lower temperature than the structures of the blade member. Moreover, as the two fluid flows 305 and 306 are admixed in the blade shank cavity, also the radially outer boundary of the rotor shaft post 123 is largely protected against direct contact with the elevated temperature second fluid flow 305. The skilled person will further appreciate that both fluid flows 305 and 306 are guided radially outwardly. Thus, the fluid flows, and in turn the purging of the blade shank cavities 330, benefits from a radial pumping effect on the fluid flows 305 and 306 upon the rotation of the rotor. The front side of the blade coolant supply plenum 320 may be provided with a metering orifice in order to limit the fluid flow 306 from the blade coolant supply plenum to the blade shank cavity. Such metering orifice may for instance be provided by a lug provided on the blade root. Aperture 131 or other ducts, such as for instance formed, in an assembled state, by flutes 132, 133, 134 described in connection with FIG. 4 below, may be sized and configured to provide a metering device for the second fluid flow.

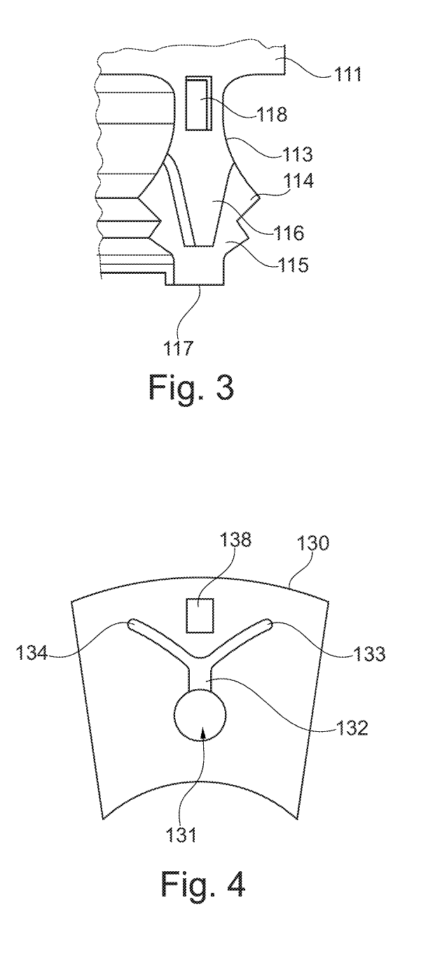

An exemplary part view of the blade foot section of an exemplary blade member as may be used in conjunction with the embodiments shown in FIGS. 1 and 2 is depicted in FIG. 3. On the coolant side of a blade platform 111 blade shank 113 and blade root 114 are provided. On the front face of the blade foot section a V-shaped recessed section 115 is provided, and/or a wedge-shaped protrusion 116 is provided, respectively. When a cover plate is attached to the front face of the blade foot section, and is firmly seated on protrusion 116, a first blade shank cavity supply duct for the first fluid flow, which is extracted from below the blade root and this guided to the blade shank cavities, is provided between the recessed section 115 and the cover plate. Moreover, a locking recess 118 for a mating locking feature provided on a cover plate is arranged on the front face of the blade foot section. As becomes immediately apparent, the first fluid flow flows along the interface seams formed on the rotor shaft front face, and maintains temperature of the load bearing structures low. A flow metering lug 117 is arranged at the base of the blade root, and at a front end thereof, and serves to partially block the blade coolant supply plenum 320 as shown in FIGS. 1 and 2, and thus to limit or determine, respectively, the mass flow of the first shank cavity supply fluid flow 305.

With reference to FIG. 4 a cover plate 130 as may be used in conjunction with the blade member of FIG. 3 in a turboengine rotor shown in FIGS. 1 and 2 is shown. The figure shows a view on a face of the cover plate which is intended to face the rotor front face. An aperture 131 is provided in particular in a radially inner half of the cover plate. Said aperture penetrates the cover plate 130 such as to provide a fluid connection between two faces of the cover plate. Flute 132 is provided on the face of the cover plate 132. Flute 132 is in fluid communication with aperture 131. It should be noted, although apparent to the person skilled in the art, that flute 132 does not penetrate the cover plate. Flute 132 extends radially outwardly from aperture 131 and branches off into two branches 133 and 134. When cover plate 130 is mounted on a rotor face, with the face shown in the figure facing the rotor front face, aperture 131 may be arranged in a radial region of a blade root. The radially extending part of flute 132 may for instance be covered by the protruding face 116 of the blade foot section shown in FIG. 3. Thus, a duct is formed. The branches 133 and 134 will be arranged such as to run along the front face of the blade foot section and continue laterally thereof, such as to provide fluid communication between aperture 131 and the blade shank cavity. Thus, when a rotor is assembled, comprising for instance a blade with the blade foot section as depicted in FIG. 3 and a cover plate as depicted in FIG. 4, flute 132 with two branches 133 and 134 provides a second blade shank cavity supply duct with an upstream end provided at aperture 131 and a downstream end provided in respective blade shank cavities. Cover plate 130 further comprises a mating locking feature 138 which is intended to mate for instance with locking recess 118 as depicted in FIG. 3.

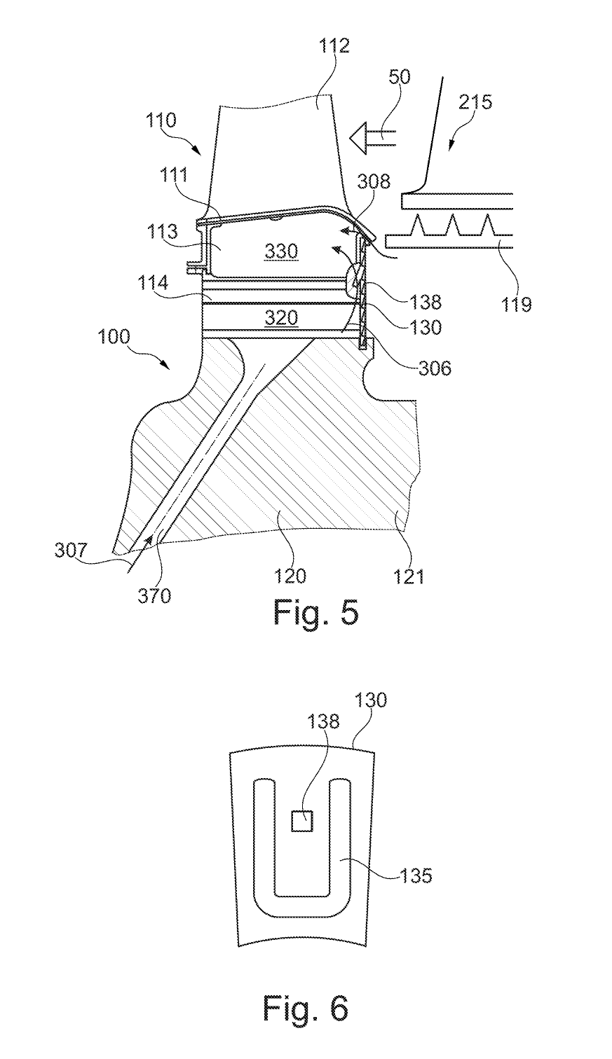

A further embodiment of applying the method and the device according to the present disclosure is shown in FIG. 5. Shown is a blade 110 of a downstream turbine stage. Main working fluid flow 50 is flowing from an upstream stationary turbine guide vane 215 to an airfoil 112 of the blade member 110. On the rotor 100, a rotor heat shield 119 is attached in any appropriate manner, while omitting any details. As is appreciated by the person skilled in the art, pre-used coolant at an elevated temperature is present in the wheel cavity 340 formed between the rotor shaft 120 and the rotor heat shield 119, and upstream of blade member 110. Blade member 110 further comprises a blade foot section comprising shank 113 and blade root 114, and a blade platform 111 interposed between the foot section and the airfoil 112. Fixation features provided on the blade root 114 are received by fixation features provided by rotor shaft posts, for instance, in a manner as lined out in connection with FIGS. 1 and 2. To this extent, the blade root 114 may be a fir tree root, and corresponding fir tree grooves may be provided in the rotor shaft and open towards the front face of the rotor. The rotor front face may again be an annular rim, arranged around a rotor shaft core 121. The rotor front face faces wheel cavity 340. In a manner lined out in connection with FIGS. 1 and 2, blade shank cavity 330 is formed below the blade platform 111, and blade coolant supply plenum 320 is provided between the blade root 114 and the bottom of grooves formed between rotor shaft posts. Blade coolant supply plenum 320 is in fluid communication with the blade coolant supply duct 370 provided in the rotor shaft. A blade coolant flow 307 and there's blade coolant supply plenum 320 through blade coolant supply duct 370. Blade coolant supply plenum 320 may in particular be in fluid communication with cooling ducts provided in the blade airfoil 112 through ducts formed in the blade foot section. A cover plate 130 is provided on the annular rotor front face to seal the cavities 320 and 330 against ingestion of heated fluid from wheel cavity 340, and moreover to fix the blade on the rotor shaft in axial direction. Cover plate 130 may on a radially inner side be received in a groove provided on the rotor shaft, and at its radially outer side in a groove provided by the platform. Circumferential locking of the locking plate may be achieved through locking feature 138 which may be received in a counterpart locking recess of the rotor front face. The counterpart locking recess may for instance be provided on the front face of the blade foot section, as lined out in more detail in conjunction with FIG. 3. While it may be possible to achieve an almost leakage-free sealing effect on one of said radially inner and outer sides of the locking plate, due to, for instance, manufacturing tolerances, differential thermal expansion and other influencing parameters a certain play may need to be provided on the other side. While for instance an appropriate sealing with the rotor shaft may be provided on the radially inner side, and, moreover by the pressure inside blade coolant supply plenum 320, some play may need to be provided between the platform groove and the locking plate. Consequently a certain leakage flow 308 form wheel space 340 and into blade shank cavity 330 may be unavoidable, and any improvement of the sealing effect may turn out very expensive. According to the present disclosure, a fluid flow 306 is guided from the blade coolant supply plenum 320 and into blade shank cavity 330, where it is admixed with the leakage flow 308 to form a combined platform coolant and/or cavity purging flow. As will be appreciated, the temperature of the combined platform coolant flow is lower than the temperature of the leakage flow 308, provided the fluid supplied to the blade coolant supply plenum 320 is colder than the pre-used coolant in wheel cavity 340. The amount by which the combined fluid flow will be colder than the leakage flow 308 will depend upon the temperature difference between and the mass flow ratio of the leakage flow 308 and the blade shank cavity supply flow 306. Moreover, as also lined out above, the first blade shank cavity supply flow 306 which originates from the blade coolant supply plenum 320 is guided along the interface seam between the blade root and the rotor shaft formed on the rotor front face. Thus, again, the load bearing rotor shaft structures are protected from the hot leakage flow 308 as well as from the combined platform coolant flow. Thus, the interface seams are exposed to the coldest available fluid flow at this location. Blade shank cavity supply ducts providing fluid communication between blade coolant supply plenum 320 and blade shank cavity 330 are, as lined out above, provided between the rotor front face and the cover plate 130. Suitable means to provide a blade shank cavity supply duct may be provided on the rotor front face, on the cover plate, or a combination thereof. Throttling and/or metering means may be provided between the blade coolant supply plenum and the blade shank cavity in order to limit and/or determine the mass flow of fluid flowing from the blade coolant supply plenum to the blade shank cavity. By virtue of the herein described method, and further of the herein described devices, it is possible to save considerably on sealing expense, in particular on the radially outer side of the cover plate in the present embodiment, to tolerate larger leakage flows from an upstream wheel space, and further to recuperate a part of the pre-used coolant in wheel space 340 and to save dedicated blade shank cavity supply fluid.

An exemplary embodiment of a locking plate as may be used in conjunction with the embodiment of FIG. 5 is shown in FIG. 6. Depicted is a view onto a face of a cover plate which is intended to face the rotor face. A U-shaped flute 135 is present on said face. It is noted, that flute 135 does not penetrate cover plate 130; cover plate 130 does not provide any fluid communication between its two faces. When cover plate 130 is mounted on the rotor front face as indicated in FIG. 5, the radially inner part of flute 135 is open towards the blade coolant supply plenum 320. A radially outer end of the radial branches of flute 135 is open towards the blade shank cavity. The radial branches of flute 135 extend along the interface seams formed on the rotor front face. The face of the cover plate 130 is at least essentially flush with the rotor front face. Thus, flute 135 provides fluid communication between blade coolant supply plenum 320 and blade shank cavity 330, through which fluid flow 306 may flow from blade coolant supply plenum 320 to blade shank cavity 330, while purging the interface seam formed between the blade root and the rotor posts on the rotor front face. Further, locking feature 138 for locking cover plate 130 to the rotor front face and fixing it in circumferential direction is shown.

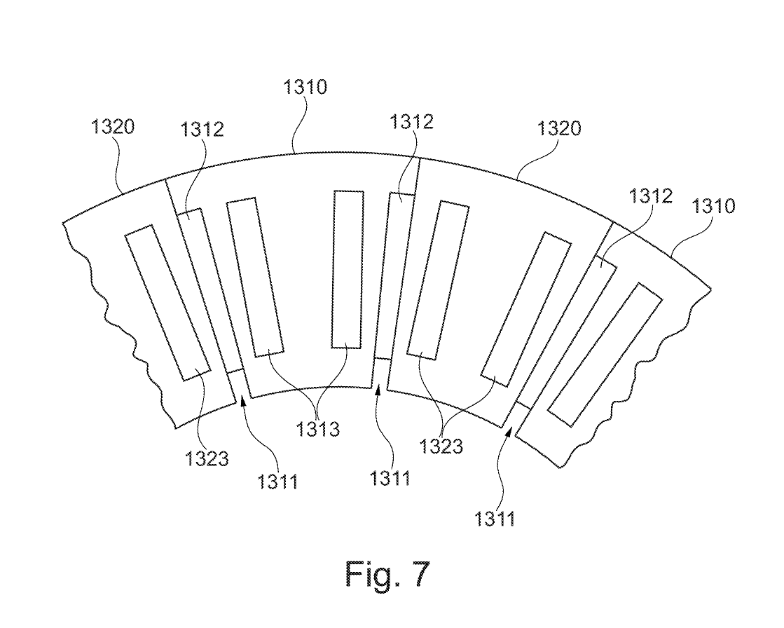

A further embodiment of a cover plate arrangement as may be used in connection with the engine embodiment shown in FIG. 1 is depicted in FIG. 7. Cover plates 1310 and 1320 are alternatingly arranged around the circumference of the rotor front face. Each first cover plate 1310 comprises recesses 1311 provided at radially inner edges thereof. When mounted on the rotor front face, and in connection with the second cover plate 1320, said recesses form apertures similar to apertures 131 in FIG. 4, which are in fluid communication with flutes 1312, which in turn are provided on a front face of the cover plate 1310 which is intended to face the rotor front face. Thus, when mounted on the rotor front face, recesses 1311 and flutes 1312 constitute a duct for the second fluid flow flowing from the rim cavity 310 in FIG. 1 through recesses 1311 and flutes 1312 into the blade shank cavity. Furthermore, flutes 1313 are provided on cover plate 1310, and serve as a duct for the first fluid flow flowing from a blade coolant supply plenum into the blade shank cavities. Moreover, flutes 1323 are provided on second cover plates 1320, and provide a duct for a first fluid flow flowing from a blade coolant supply plenum and into the blade shank cavities. The cover plates 1310 and 1320 may be arranged in the circumferential direction such that the flutes 1312 are arranged in line with the front faces of the rotor shaft posts. In further conceivable embodiments flutes 1312 may at be provided with branches extending in a circumferential direction, similar to those shown in FIG. 4, and may then be arranged in line with front faces of the blade roots. It is mandatory, however, to arrange the cover plates in the circumferential direction such that flutes 1323 and 1313 are always in line with the interface seams formed between the blade roots and the rotor shaft posts, such as to always provide the cooler first fluid flow over said heavily loaded interface structures, and thus to shield them from the comparatively warmer fluid flowing in flutes 1312.

While the subject matter of the disclosure has been explained by means of exemplary embodiments, it is understood that these are in no way intended to limit the scope of the claimed invention. It will be appreciated that the claims cover embodiments not explicitly shown or disclosed herein, and embodiments deviating from those disclosed in the exemplary modes of carrying out the teaching of the present disclosure will still be covered by the claims.

### LIST OF REFERENCE NUMERALS

50 working fluid main flow
100 rotor
110 blade member
111 platform
112 airfoil
113 shank
114 blade root
115 recessed section
116 protrusion
117 flow metering lug
118 locking recess
119 rotor heat shield
120 rotor shaft
121 rotor shaft core
122 rotor front face, rotor rim
123 rotor shaft post
130 cover plate
131 aperture
132 flute
133 flute, branch of flute
134 flute, branch of flute
135 flute
138 locking feature
140 downstream cover plate
200 stator
210 stationary guide vane
215 stationary guide vane
220 stator segment
300 coolant duct
301 rotor main coolant flow
302 share of coolant flow
303 share of coolant flow, rim cavity flow
304 rim cavity purge flow
305 second fluid flow, second blade shank cavity supply flow
306 first fluid flow, first blade shank cavity supply flow
307 combined blade shank cavity fluid flow
308 leakage flow
310 rim cavity
320 blade coolant supply plenum
330 blade shank cavity, shank cavity
340 wheel cavity
350 seal
360 labyrinth seal
370 blade coolant supply duct
1310 first cover plate
1311 recess, aperture
1312 flute
1313 flute
1320 second cover plate
1323 flute

1. A method for cooling a turboengine rotor, the rotor including a rotor shaft and at least one blade member, the blade member including a platform, wherein the platform includes a hot gas side and a coolant side, an airfoil being provided on the platform hot gas side and a blade foot section being provided on the platform coolant side, wherein the blade foot section includes a blade shank and a blade root, wherein the blade shank extends from the platform coolant side and is interposed between the blade root and the platform coolant side, the blade root including root fixation features being provided on the blade root and being received by a fixation feature of the rotor shaft, wherein the rotor shaft fixation feature extends from a rotor front face and is provided on posts formed on the rotor shaft; an interconnection interface being formed between the fixation features being provided on the blade root and the rotor shaft, and extending to the rotor front face and forming an interface seam on the rotor front face; and a blade shank cavity being provided adjacent the platform coolant side, the method comprising:
guiding a first fluid flow along the rotor front face and into the blade shank cavity;
a second fluid flow entering the blade shank cavity;
choosing a source of the first fluid flow such that the first fluid flow is relatively colder than the second fluid flow; and
admixing the second fluid flow with the first fluid flow inside the blade shank cavity to form a combined shank cavity fluid flow.

2. The method according to claim 1, wherein the first fluid flow is selectively guided over the interface seam present on the rotor front face before entering the blade shank cavity.

3. The method according to claim 1, comprising:
extracting the first fluid flow from a coolant plenum which is provided between a base of a groove provided between two adjacent rotor posts and the blade root.

4. The method according to claim 1, comprising:
guiding the second fluid flow along a front face of at least one of the blade root and the rotor shaft post from a location radially inwardly from the blade shank cavity and into the blade shank cavity.

5. The method according to claim 1, wherein the second fluid flow is a flow of pre-used coolant.

6. The method according to claim 1, wherein the second fluid flow originates from a cavity provided adjacent the rotor front face.

7. The method according to claim 1, wherein the first fluid flow and the second fluid flow enter the cavity separate from each other.

8. A turboengine rotor, the rotor comprising:
a rotor shaft and at least one blade member, the blade member including a platform, wherein the platform includes a hot gas side and a coolant side, an airfoil being provided on the platform hot gas side and a blade foot section being provided on the platform coolant side, wherein the blade foot section includes a blade shank and a blade root, wherein the blade shank extends from the platform coolant side and is interposed between the blade root and the platform coolant side, the blade root including root fixation features being provided on the blade root and being received by a fixation feature of the rotor shaft, wherein the rotor shaft fixation feature extends from a rotor front face and is provided on posts formed on the rotor shaft;
an interconnection interface being formed between the fixation features being provided on the blade root and the rotor shaft, and extending to the rotor front face and forming an interface seam on the rotor front face; and
a blade shank cavity being provided adjacent the platform coolant side,
wherein a first shank cavity supply duct is provided on the rotor front face and along the interface seam and is in fluid communication with the blade shank cavity.

9. The turboengine rotor according to claim 8, wherein a blade coolant supply plenum is provided between a base of a groove formed between two adjacent rotor shaft posts and the blade root and is in fluid communication with cooling ducts of the airfoil, wherein the first shank cavity supply duct is in fluid communication with the blade shank cavity at a downstream end and is in fluid communication with the blade coolant supply plenum at an upstream end, wherein a metering orifice is provided in a flow path between the blade coolant supply plenum and the first shank cavity supply duct.

10. The turboengine rotor according claim 8, wherein a second shank cavity supply duct is provided and is in fluid communication with the blade shank cavity at a downstream end, wherein said second shank cavity supply duct is provided along a front face of at least one of the blade root and the rotor shaft post, and an upstream end of the second shank cavity supply duct is provided radially inwardly from the downstream end.

11. The turboengine rotor according to claim 8, wherein a cover plate is provided covering at least a part of the front face, wherein the first and second shank cavity supply ducts are provided between the front face and the cover plate.

12. The turboengine rotor according to claim 11, wherein an upstream end of the second shank cavity supply duct is provided as an aperture in the cover plate.

13. A cover plate for a turboengine rotor according to claim 11, the cover plate comprising a first face and a second face and having a radial and a circumferential extent, the first face being configured and arranged to be mounted facing the rotor front face, wherein:
at least one flute is provided on the first face of the cover plate, said flute being arranged and configured to form a blade shank cavity supply duct when the cover plate is mounted on the rotor front face, the at least one flute extending from a radially inner position to a radially outer position.

14. A cover plate for a turboengine rotor according to claim 11, the cover plate comprising:
a first face and a second face and having a radial and a circumferential extent, the first face being configured and arranged to be mounted facing the rotor front face, wherein an aperture extends from the first to the second face, wherein the aperture is provided on a radially inner half of the cover plate and at least one flute is provided on the first face of the cover plate, said flute being arranged and configured to form a shank cavity supply duct when the cover plate is mounted on the rotor front face, wherein said at least one flute extends from the aperture to a position which is located on a larger radius than the aperture.
